(19) United States
(12) Patent Application Publication
(10) Pub. No.: US 2010/0101822 A1
(43) Pub. Date: Apr. 29, 2010

(54) Stress/Thermal Cracking Resistant Cable Sheath Material

(76) Inventors: Shana P. Bunker, High Bridge, NJ (US); Jeffrey M. Cogen, Flemington, NJ (US); Suzanne Guerra, Lake Jackson, TX (US)

Correspondence Address: WHYTE HIRSCHBOECK DUDEK S.C./DOW;Intellectual Property Department, 555 East Wells Street, Suite 1900, Milwaukee, WI, 53202, US

(21) Appl. No.: 12/529,480

(22) PCT Filed: Feb. 20, 2008
(86) PCT No.: PCT/US08/54398

§ 371 Date: Sep. 1, 2009

Related U.S. Application Data
(60) Provisional application No. 60/893,931, filed on Mar. 9, 2007.

(51) Int. Cl. H01B 3/30; C08K 5/101

(52) U.S. Cl. 174/110 SR; 524/315; 977/742

(57) ABSTRACT

A composition useful as a wire or cable insulation or sheathing layer, the composition comprising (i) an inorganic flame retardant, e.g., aluminum trihydroxide (ATH), (ii) ethylene ethyl acetate (EEA) or ethylene butyl acrylate (EBA), (iii) a homogeneous polyethylene, (iv) an ethylenic resin modified with an organo-functional group, e.g., maleic anhydride (MAH) grafted polyethylene, (v) a silicone polymer, and optionally, (vi) a smoke suppressant. The insulation or sheathing layer comprising the composition of this invention exhibits good resistance to stress and/or thermal cracking.

### FIELD OF THE INVENTION

This invention relates to jacketing material. In one aspect, the invention relates to jacketing material for wire and cable while in another aspect, the invention relates to jacketing material comprising, among other things, a halogen-free flame retardant, an ethylene-ethyl acrylate (EEA) or ethylene-butyl acrylate (EBA), and a homogeneous polyethylene. In still another aspect, the invention relates to a jacketing material that exhibits good resistance to stress and/or thermal cracking.

### BACKGROUND OF THE INVENTION

Polyolefin resins are commonly used as a material for the sheath layers, e.g., insulation, outer jacket, etc., of wires and cables. To impart flame retardance to these layers, however, additives often must be blended with the polyolefin resins. These additives include organic halogenated compounds and flame retardant aids such as antimony trioxide. Unfortunately, these additives can cause smoking and/or the emission of harmful gases when subjected to burning, and can also cause metals to corrode.

To address these problems, the halogenated flame retardant is often replaced with a non-halogenated flame retardant such as a metal hydroxide. The use of a non-halogenated flame retardant, however, has its own problems. One principal problem is that a considerable amount of non-halogenated flame retardant is necessary to achieve the same level of flame retardance as that achieved from using a halogenated flame retardant. Not only does this higher loading of flame retardant adversely affect the polyolefin resin in terms of extrudability, mechanical properties, flexibility, and low temperature performance, but it also increases the susceptibility of the polyolefin resin in the form of a wire or cable insulation or sheathing to stress and thermal cracking. In the case of magnesium hydroxide (Mg(OH)₂), the cracking is sometimes attributable to large agglomerations of Mg(OH)₂. Low cost Mg(OH)₂ typically are not surface coated, and thus have a relatively high surface energy (>90 mJ/m²) and this, in turn, can result in a high level of agglomeration in the wire or cable insulation or sheath. Higher cost, surface coated Mg(OH)₂ is also known to crack in insulation or sheath layers comprising EEA.

### SUMMARY OF THE INVENTION

In one embodiment, the invention is a wire or cable sheathing layer comprising (i) an non-halogenated flame retardant, e.g., aluminum trihydroxide (ATH), (ii) EEA or ethylene-butyl acrylate (EBA), (iii) a homogeneous polyethylene, (iv) a maleic anhydride (MAH) grafted polyethylene, (v) a silicone polymer, and (vi) optionally, a smoke suppressant, the insulation or sheathing layer exhibiting good resistance to stress and/or thermal cracking.

In another embodiment, the invention is a cable comprising at least one of (i) one or more electrical conductors or communications media, and (ii) a core of two or more electrical conductors or communications media, at least one of the electrical conductor, communications medium, or core being surrounded by a sheath or insulation layer comprising:
(A) 15 to 25 wt % of at least one of EEA and EBA;
(B) 5 to 15 wt % of a homogeneous polyethylene;
(C) 3 to 12 wt % of an ethylenic resin modified with a compound or compounds containing a functional group;
(D) 40 to 65 wt % of a non-halogenated flame retardant;
(E) 1 to 8 wt % of a silicone polymer; and, optionally,
(F) 0 to 20 wt % of a smoke suppressant.

### DESCRIPTION OF THE PREFERRED EMBODIMENTS

The numerical ranges in this disclosure include all values from and including the lower and the upper values, in increments of one unit, provided that there is a separation of at least two units between any lower value and any higher value. As an example, if a compositional, physical or other property, such as, for example, molecular weight, viscosity, melt index, etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, melt index, polydispersity or molecular weight distribution (Mw/Mn), percent comonomer, and the number of carbon atoms in a comonomer.

“Polymer” means a polymeric compound prepared by polymerizing monomers, whether of the same or a different type. The generic term polymer thus embraces the term homopolymer, usually employed to refer to polymers prepared from only one type of monomer, and the term interpolymer as defined below.

“Interpolymer” means a polymer prepared by the polymerization of at least two different types of monomers. This generic term includes copolymers, usually employed to refer to polymers prepared from two different types of monomers, and polymers prepared from more than two different types of monomers, e.g., terpolymers, tetrapolymers, etc.

“Blend”, “polymer blend” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates.

“Cable” and like terms mean at least one wire or optical fiber within a protective jacket or sheath. Typically, a cable is two or more wires or optical fibers bound together, typically in a common protective jacket or sheath. The individual wires or fibers inside the jacket may be bare, covered or insulated. Combination cables may contain both electrical wires and optical fibers. The cable, etc. can be designed for low, medium and high voltage applications. Typical cable designs are illustrated in U.S. Pat. Nos. 5,246,783, 5,889,087, 6,496,629 and 6,714,707.

“Sheath” and like terms mean a protective wrapping, coating or other enveloping structure, usually polymeric in composition, about one or more wires or optical fibers.

Insulation jackets are sheaths typically designed to protect to wires and/or optical fibers, or bundles of wires and/or optical fibers, from water and static electricity. Insulation jackets are usually, but not always, an interior component of a cable. Outer or protective jackets are sheaths typically designed as the outermost layer of a cable to provide the other components of the cable protection from the environment and physical insult. Outer jackets may also provide protection against static electricity.

“Core” and like terms mean one or more wire or optical fiber, usually a bundle of wire and/or optical fibers, within a single sheath and that forms a central component of a cable. Each wire, optical fiber and/or bundle of wire and/or optical fiber within a core can be bare or enveloped with its own sheath.

Density is determined in accordance with American Society for Testing and Materials (ASTM) procedure ASTM D792-00, Method B.

Melt index (I₂) in g/10 min, is measured using ASTM D-1238-04 (version C), Condition 190 C/2.16 kg. The notation “I₁₀” refers to a melt index, in g/10 min, measured using ASTM D-1238-04, Condition 190 C/10.0 kg. The notation “I₂₁” refers to a melt index, in g/10 min, measured using ASTM D-1238-04, Condition 190 C/21.6 kg. Polyethylene is typically measured at 190 C while polypropylene is typically measured at 230 C.

Differential Scanning Calorimetry (DSC) is performed using a TAI model Q1000 DSC equipped with an RCS cooling accessory and an auto-sampler. The apparatus is purged with a nitrogen gas flow (50 cc/min). The sample is pressed into a thin film and melted in the press at about 175 C and then air-cooled to room temperature (25 C). Material (3-10 mg) is then cut into a 3 mm diameter disk, accurately weighed, placed in a light aluminum pan (ca 50 mg), and then crimped shut. The thermal behavior of the sample is investigated with the following temperature profile. The sample is rapidly heated to 180 C and held isothermally for 3 minutes in order to remove any previous thermal history. The sample is then cooled to −90 C at 10 C/min cooling rate and held at −90 C for 3 minutes. The sample is then heated to 150 C at 10 C/min heating rate. The cooling and second heating curves are recorded.

EEA and EBA, i.e., the base resin (A), are copolymers comprising units derived from ethylene and one of ethyl acrylate and butyl acrylate, or both, using a conventional high pressure process and a free radical initiator, e.g., an organic peroxide, at a temperature in the range of 150 to 350 C and a pressure of 100 to 300 MegaPascal (MPa). The amount of units derived from ethyl acrylate or butyl acrylate, i.e., the comonomer, present in EEA or EBA is at least 5, and preferably at least 10, wt % based on the weight of the copolymer. The maximum amount of units derived from ethyl acrylate or butyl acrylate present in the copolymer typically does not exceed 40, and preferably does not exceed 35, wt % based on the weight of the copolymer. The EEA and EBA typically have a melt index (MI) in the range of 0.5 to 50 g/10 min.

EEA and/or EBA is present in the composition is an amount of at least 15, preferably at least 17 and more preferably at least 18, wt % based on the weight of the composition. The maximum amount of base resin (A) present in the composition typically does not exceed 25, preferably it does not exceed 23 and more preferably it does not exceed 21, wt % based on the weight of the composition.

Base resin (B) is a homogeneous polyethylene or a blend of two or more homogeneous polyethylenes. These homogeneous polyethylenes are copolymers of ethylene, one or more α-olefins and, optionally, a diene. The copolymer is a polymer formed from the polymerization of two or more monomers and includes terpolymers, tetramers and the like. The α-olefins can have 3 to 12 carbon atoms, preferably 3 to 8 carbon atoms.

As here used, “homogeneous” interpolymers are interpolymers in which the comonomer is randomly distributed within a given interpolymer molecule and in which substantially all of the interpolymer molecules have the same ethylene/comonomer ratio within that interpolymer. In contrast, “heterogeneous” interpolymers are interpolymers in which the interpolymer molecules do not have the same ethylene/comonomer ratio. The homogeneous polyethylenes are also characterized by single and relatively low DSC melting points. Homogeneous interpolymers are further described in U.S. Pat. No. 3,645,992.

Examples of α-olefin comonomers include propylene, 1-butene, 1-hexene, 4-methyl-1-pentene and 1-octene. The copolymers have a polydispersity (Mw/Mn) in the range of 1.5 to 3.5. Mw is defined as weight average molecular weight, and Mn is defined as number average molecular weight. The homogeneous polyethylenes can have a density in the range of 0.86 to 0.94 g/cc, preferably a density less than 0.90 g/cc.

The preferred homogeneous polyethylenes for use in the practice of the invention have a density of less than 0.90 g/cc, an MI of 1 to 10 g/10 min, and a polydispersity of 3.3 or less.

Homogeneous polyethylenes can be prepared, for example, with vanadium-based catalyst systems such as those described in U.S. Pat. Nos. 5,332,793 and 5,342,907. Homogeneous polyethylenes can also be prepared with single site metallocene catalyst systems such as those described in U.S. Pat. Nos. 4,937,299 and 5,317,036, and with constrained geometry catalysts such as those described in U.S. Pat. No. 6,538,070.

Commercial examples of homogeneously branched linear ethylene/α-olefin interpolymers include the ENGAGE™ and AFFINITY™ polymers available from The Dow Chemical Company, the TAFMER™ polymers supplied by the Mitsui Chemical Company, and the EXACT™ polymers supplied by ExxonMobil Chemical Company.

The homogeneous polyethylene is present in the composition an amount of at least 5, preferably at least 7 and more preferably at least 8, wt % based on the weight of the composition. The maximum amount of the homogeneous polyethylene present in the composition typically does not exceed 15, preferably it does not exceed 13 and more preferably it does not exceed 12, wt % based on the weight of the composition.

The ethylenic resin modified with an organo-functional group, i.e., base resin (C), of the present invention is obtained by modification of an ethylenic resin with a chemical compound containing an organo-functional group. An ethylenic resin is simply one wherein the primary monomer is ethylene. Examples of organo-functional group containing chemical compounds are unsaturated carboxylic acids such as fumaric acid, acrylic acid, maleic acid, crotonic acid and citraconic acid; unsaturated aliphatic diacid anhydrides such as maleic anhydride, itaconic anhydride, citraconic anhydride, 5-norbornene-2,3-dicarboxylic anhydride, 4-methyl cyclohexene-1,2-dicarboxylic anhydride, and 4-cyclohexene-1,2-dicarboxylic anhydride; epoxy compounds such as glycidyl acrylate, glycidyl methacrylate, and allyl glycidyl ether; hydroxy compounds such as 2-hydroxyethyl acrylic acid, 2-hydroxyethyl methacrylic acid, and polyethylene glycol mono-acrylate; metal salts such as sodium acrylate, sodium methacrylate, and zinc acrylate; silane compounds such as vinyl tri-chloro silane, vinyl tri-ethoxy silane, vinyl tri-methoxy silane, and methacryloxy propyl tri-methoxy silane.

The ethylenic resins, in unmodified form, can have a melt index in the range of 0.1 to 50 g/10 min and a density in the range of 0.86 to 0.95 g/cc. They can be any ethylene/α-olefin copolymer produced by conventional methods using Ziegler-Natta catalyst systems, Phillips catalyst systems, or other transition metal catalyst systems. Thus, the copolymer can be a very low density polyethylene (VLDPE), ultra low density polyethylene (ULDPE), a linear low density polyethylene (LLDPE), a medium density polyethylene (MDPE) having a density in the range of 0.926 to 0.94 g/cc, or a high density polyethylene (HDPE) having a density greater than 0.94 g/cc. These ethylenic resins also include such resins as EVA, EEA, high pressure low density polyethylene (HP-LDPE, a homopolymer), or ethylene/α-olefin copolymers produced by employing single site metallocene catalysts or CGCs. These ethylenic resins can be referred to generically as polyethylenes.

An amount of the above-mentioned organo-functional group containing chemical compound to be added to modify the ethylenic resin is preferably in the range of 0.05 to 10 wt % based on the weight of the resin. Modification can be accomplished by, for example, solution, suspension, or melting methods. The solution method comprises mixing an organo-functional group containing chemical, an ethylenic resin, a non-polar organic solvent and a free radical initiator such as an organic peroxide, and then heating the mixture to 100 to 160 C to perform the modification reaction. Hexane, heptane, benzene, toluene, xylene, chlorobenzene and tetra-chloroethane are examples of non-polar solvents. 2,5-dimethyl-2,5-di(t-butyl peroxy) hexane, 2,5-dimethyl-2,5-di(t-butyl peroxy) hexyne-3, and benzoyl peroxide are examples of organic peroxides. In the melting method, the ethylenic resin, the organo-functional group containing chemical compound and a free radical initiator are introduced into a melting-kneading machine such as an extruder and BANBURY™ mixer to obtain the modified ethylenic resin.

The modified polymer, e.g., an anhydride grafted polymer, can contain 0.05 to 5 or 10 parts by weight of anhydride per 100 parts by weight of polymer, and preferably it contains 0.1 to 2 parts by weight of anhydride per 100 parts by weight of polymer.

Anhydride modification can be accomplished by, for example, the copolymerization ethylene and maleic anhydride, and optionally comonomers such as ethyl acrylate. The polymerization technique is a conventional high pressure polymerization of the underlying comonomers. Reference can be made to Maleic Anhydride, Trivedi et al, Polonium Press, New York, 1982, Chapter 3, section 3-2. This treatise also covers grafting.

The ethylenic resin modified with an organo-functional group is present in the composition is an amount of at least 3, preferably at least 4 and more preferably at least 5, wt % based on the weight of the composition. The maximum amount of base resin (C) present in the composition typically does not exceed 12, preferably it does not exceed 10 and more preferably it does not exceed 8, wt % based on the weight of the composition.

Examples of the non-halogenated flame-retardant, i.e., component (D), employed in the present invention include: ATH, red phosphorous, silica, alumina, titanium oxide, carbon nanotubes, talc, clay, organo-modified clay, calcium carbonate, zinc borate, antimony trioxide, wollastonite, mica, ammonium octamolybdate, frits, hollow glass microspheres, intumescent compounds and expanded graphite. The preferred non-halogenated flame retardant is ATH.

The non-halogenated flame retardant is present in the composition is an amount of at least 40, preferably at least 45 and more preferably at least 50, wt % based on the weight of the composition. The maximum amount of non-halogenated flame retardant present in the composition typically does not exceed 65, preferably it does not exceed 60 and more preferably it does not exceed 55, wt % based on the weight of the composition.

The non-halogenated flame retardant can be surface treated (coated) with a saturated or unsaturated carboxylic acid having about 8 to about 24 carbon atoms and preferably about 12 to about 18 carbon atoms or a metal salt of the acid, but a coating is optional. Mixtures of these acids and/or salts can be used, if desired. Examples of suitable carboxylic acids are oleic, stearic, palmitic, isostearic, and lauric; of metals which can be used to form the salts of these acids are zinc, aluminum, calcium, magnesium, and barium; and of the salts themselves are magnesium stearate, zinc oleate, calcium palmitate, magnesium oleate, and aluminum stearate. The amount of acid or salt can be in the range of 0.1 to 5 parts of acid and/or salt per one hundred parts of metal hydrate and is preferably 0.25 to 3 parts per one hundred parts of metal hydrate. The surface treatment is described in U.S. Pat. No. 4,255,303. The acid or salt can be merely added to the composition in like amounts rather than using the surface treatment procedure, but this is not preferred. Other surface treatments known in the art may also be used including silanes, titanates, phosphates and zirconates.

The silicone polymer, i.e., component (E), employed in the invention is exemplified by the following formula:

R—Si—O—(RSiO)ₙ—R—Si—O—R

in which each R is independently a saturated or unsaturated alkyl group, an aryl group, or a hydrogen atom, and n is 1 to 5000. Typical R groups are methyl, ethyl, n-propyl, isopropyl, n-butyl, isobutyl, phenyl and vinyl. Preferably R is methyl. The silicone can also be a silicate, silicone oil or the like, and examples of these include glycidyl-modified silicate, amino-modified silicate, mercapto-modified silicate, polyether-modified silicate, carboxylic acid modified silicate, or higher fatty acid modified silicate. The viscosity of the silicone polymer can be in the range of 1,000 to 100,000,000 centistokes at 23 C. The viscosities of the silicones are preferably above 5,000,000 centistokes, and most preferably above 10,000,000 centistokes at room temperature (23 C).

Silicone polymer is present in the composition is an amount of at least 1, preferably at least 2 and more preferably at least 3, wt % based on the weight of the composition. The maximum amount of silicone polymer present in the composition typically does not exceed 8, preferably it does not exceed 7 and more preferably it does not exceed 6, wt % based on the weight of the composition.

The smoke suppressant, i.e., optional component (F), effectively reduces the amount of aromatic species released as smoke by promoting char development during a fire. Commercial smoke suppressants include various forms of zinc borate, magnesium/zinc/antimony complexes, magnesium/zinc complexes and anhydrous sodium antimonates all available from GLCC Laurel, LLC. Smoke suppressant (F) is optional in the compositions of the present inventions but if it is present, then it is present an amount of at least 1, preferably at least 3 and more preferably at least 5, wt % based on the weight of the composition. The maximum amount of smoke suppressant present in the composition typically does not exceed 20, preferably it does not exceed 15 and more preferably it does not exceed 10, wt % based on the weight of the composition. The preferred smoke suppressant is magnesium hydroxide (which forms MgO during combustion) since the magnesium hydroxide also contributes as a flame retardant.

The resin components of this invention, i.e., components (A), (B) and (C), can be combined with conventional additives provided that the particular additive chosen will not adversely affect the composition. The additives can be added to the resin composition prior to or during the mixing of the components, or prior to or during extrusion. The additives include antioxidants, ultraviolet absorbers or stabilizers, antistatic agents, pigments, dyes, nucleating agents, reinforcing fillers or polymer additives, resistivity modifiers such as carbon black, slip agents, plasticizers, processing aids, lubricants, viscosity control agents, tackifiers, anti-blocking agents, surfactants, extender oils, metal deactivators, voltage stabilizers, fillers, flame retardant additives, and crosslinking boosters and catalysts. Additives can be added in amounts ranging from less than 0.1 to more than 5 parts by weight for each 100 parts by weight of the resin. Fillers are generally added in larger amounts up to 200 parts by weight or more.

Examples of antioxidants are: hindered and semi-hindered phenols such as tetrakis[methylene(3,5-di-tert-butyl-4-hydroxyhydrocinnamate)]-methane, bis[(beta-(3,5-ditert-butyl-4-hydroxybenzyl)-methylcarboxyethyl)]sulphide, 4,4′-thiobis(2-methyl-6-tert-butylphenol), 4,4′-thiobis(2-tert-butyl-5-methylphenol), 2,2′-thiobis(4-methyl-6-tert-butylphenol), and thiodiethylene bis(3,5-di-tert-butyl-4-hydroxy)hydrocinnamate; phosphites and phosphonites such as tris(2,4-di-tert-butylphenyl)phosphite and di-tert-butylphenyl-phosphonite; thio compounds such as dilaurylthiodipropionate, dimyristylthiodipropionate, and distearylthiodipropionate; various siloxanes; and various amines such as polymerized 2,2,4-trimethyl-1,2-dihydroquinoline. Antioxidants can be used in amounts of 0.1 to 5 parts by weight per 100 parts by weight of resin.

The various resins can be crosslinked in a conventional manner, if desired. Crosslinking is usually accomplished with organic peroxide, examples of which are mentioned with respect to grafting. The amount of crosslinking agent used can be in the range of 0.5 to 4 parts by weight of organic peroxide for each 100 parts by weight of resin, and is preferably in the range of 1 to 3 parts by weight. Crosslinking can also be effected with irradiation or moisture, or in a mold, according to known techniques. Peroxide crosslinking temperatures can be in the range of 150 to 210 C and are preferably in the range of 170 to 210 C.

The resins can also be made hydrolyzable so that they can be moisture cured. This is accomplished by grafting the resin with, for example, an alkenyl trialkoxy silane in the presence of an organic peroxide (examples are mentioned above), which acts as a free radical generator. Useful alkenyl trialkoxy silanes include the vinyl trialkoxy silanes such as vinyl trimethoxy silane and vinyl triethoxy silane. The alkenyl and alkoxy radicals can have 1 to 30 carbon atoms and preferably have 1 to 12 carbon atoms. The hydrolyzable polymers are moisture cured in the presence of a silanol condensation catalyst such as dibutyl tin dilaurate, dioctyl tin maleate, stannous acetate, stannous octoate, lead naphthenate, zinc octoate, iron 2-ethyl hexoate, and other metal carboxylates. The organic peroxides can be the same as those mentioned above for crosslinking.

The composition can also be blended and kneaded using a BANBURY™ mixer, a HENSCHEL™ mixer, a kneader, a multi-screw extruder, or continuous mixer to obtain a uniformly compounded composition.

The resin composition can be mixed and the cable coated with the resin composition can be prepared in various types of extruders, some of which are described in U.S. Pat. Nos. 4,814,135, 4,857,600, 5,076,988 and 5,153,382. A variety of types of single screw and twin screw extruders and polymer melt pumps and extrusion processes will generally be suitable in effecting the process of this invention. A typical extruder, commonly referred to as a fabrication extruder, will have a solids feed hopper at its upstream end and a melt forming die at its downstream end. The hopper feeds unfluxed plastics into the feed section of a barrel containing the processing screw(s) that flux and ultimately pump the plastic melt through the forming die. At the downstream end, between the end of the screw and the die, there is often a screen pack and a die or breaker plate. Fabrication extruders typically accomplish the mechanisms of solids conveying and compression, plastics fluxing, melt mixing and melt pumping although some two stage configurations use a separate melt fed extruder or melt pump equipment for the melt pumping mechanism. Extruder barrels are equipped with barrel heating and cooling features for startup and improved steady state temperature control. Modern equipment usually incorporates multiple heating/cooling zones starting at the rear feed zone and segmenting the barrel and downstream shaping die. The length to diameter ratio of each barrel is in the range of 15:1 to 30:1.

The advantages of the invention lie in a relatively low amount of inorganic flame retardant, excellent flame- and heat-resistance, mechanical properties superior to conventional products, good moldability, good low temperature performance, good processability and flexibility, essentially no emission of harmful gases such as halogen, and good stress/thermal resistance to cracking.

As noted, the subject cable comprises one or more electrical conductors or communications media, or a core of two or more electrical conductors or communications media, in which at least one, preferably each, electrical conductor, communications medium, or core is surrounded by a sheath or an insulation layer comprising a composition of the present invention. The electrical conductors are generally copper or aluminum and the communications media are generally fiber optics made of glass fibers.

### Specific Embodiments

Several formulations are prepared to identify the effect of the type of filler in an EEA/homogeneous polyethylene system on the stress/thermal cracking potential, as demonstrated in the Heat Shock IEC 60811-3-1 test. The compositions listed in Table 1 are extruded onto 14 gauge solid copper wire using extrusion procedures well known in the art. The resulting coated wires are then subjected to the Heat Shock test by wrapping the wire samples around a 3 mm rod in a close helical manner. The rod is then placed into a 150 C convection oven for 1 hour. The sample is removed after the test is completed and examined by the unaided eye for visible cracks. The formulation components are described below, and the formulations and resulting data are reported in Table 1. All AMPLIFY, AFFINITY and ENGAGE products are available from The Dow Chemical Company.

AMPLIFY EA 100 is an ethylene ethyl acrylate copolymer (i) comprising 15 wt % units derived from ethyl acrylate, and (ii) having a density of 0.932 g/cc, and a melt mass-flow rate (MFR, ASTM D1238 at 190 C/2.16 kg) of 1.3 g/10 min.

AMPLIFY GR 208 is a post-reactor, MAH-grafted ethylene-butene copolymer. The copolymer has a density of 0.904 g/cc, and an MFR of 3.3 g/10 min.

AFFINITY KC 8852G is an ethylene-octene copolymer (i) produced by constrained geometry catalysis, and (ii) having a density of 0.877 g/cc, and an MFR of 3 g/10 min.

AFFINITY EG 8100G is an ethylene-octene copolymer (i) produced by constrained geometry catalysis, and (ii) having a density of 0.872 g/cc, and an MFR of 1 g/10 min.

AFFINITY PL 1850G is an ethylene-α-olefin copolymer (i) produced by constrained geometry catalysis, and (ii) having a density of 0.904 g/cc, and an MFR of 3 g/10 min.

AFFINITY PL 1880G is an ethylene-α-olefin copolymer (i) produced by constrained geometry catalysis, and (ii) having a density of 0.904 g/cc, and an MFR of 1 g/10 min.

ENGAGE ENR 7380.00 is an ethylene-butene copolymer with a density of 0.872 and an MFR of 0.5 g/10 min.

ENGAGE ENR 7360.00 is an ethylene-butene copolymer with a density of 0.875 and an MFR of 1 g/10 min.

HUBERCARB G3T is calcium carbonate (3 micron average particle size) available from J.M. Huber Corporation and comprising a surface treatment of 0.75 to 1.5 percent stearic acid.

ALMATIS HYDRAL PGA is aluminum trihydroxide or (ATH) (1.6 micron average particle size) available from Mineral and Pigment Solutions, Inc.

FR-20-S10 is uncoated magnesium hydroxide with a surface area of 10 m²/g and available from Dead Sea Bromine Group.

VERTEX 60 is an uncoated grade of magnesium hydroxide with an average particle size of 1.5 micron and available from J.M. Huber Corporation.

VERTEX 60ST is an uncoated grade of magnesium hydroxide with an average particle size of 1.5 micron and available from J.M. Huber Corporation and comprising a surface treatment of a fatty acid.

KISUMA 5B-1G is magnesium hydroxide coated with oleic acid and with an average particle size of 0.65 micron available from Kyowa Chemical Industry Co., Ltd.

MAGSHIELD UF is a magnesium hydroxide with a stearate coating, and it is available from Martin Marietta Magnesia Specialties.

INDUSTRENE 5016 is stearic acid available from Chemtura.

MB50-320 masterbatch is a pelletized formulation containing 50% of an ultra-high molecular weight siloxane polymer dispersed in EVA polymer. It is available from Dow Corning Corporation.

IRGANOX 1010 is a hindered phenol based antioxidant available from Ciba Specialty Chemicals.

Table 1 reports that formulations using Mg(OH)₂ as the filler in an EEA/single-site elastomer matrix results in thermal/stress cracking, while surprisingly both the CaCO₃ and ATH formulations did not crack. The use of ATH or blend of ATH/CaCO₃ is preferred over CaCO₃ because of the better inherent flame retardation properties. While not wanting to be bound to theory, the cracking may be attributed to large agglomerates of Mg(OH)₂ compared to ATH, as shown in Table 1.

TABLE 1
Effect of Filler on the Cracking Potential
of an EEA/Homogeneous Polyethylene System

| Composition | Comp. | Comp. | Comp. | Comp. | | |
|---|---|---|---|---|---|---|
| Component | Ex. 1 | Ex. 2 | Ex. 3 | Ex. 4 | Ex. 1 | Ex. 2 |
| Amplify EA 100 | 19.7 | 19.7 | 20 | 20 | 20 | 19 |
| Amplify GR-208 | 6 | 6 | 6 | 6 | 6 | 6 |
| Affinity KC-8852G | 10.9 | 10.9 | 10.9 | 10.9 | 10.9 | 10.9 |
| Hubercarb G3T | 0 | 0 | 0 | 0 | 60 | 0 |
| PGA ATH | 0 | 0 | 0 | 0 | 0 | 60 |
| FR-20-S10 | 0 | 60 | 0 | 0 | 0 | 0 |
| Vertex 60ST | 0 | 0 | 0 | 60 | 0 | 0 |
| Vertex 60 | 60 | 0 | 0 | 0 | 0 | 0 |
| Kisuma 5B-1G | 0 | 0 | 60 | 0 | 0 | 0 |
| Industrene 5016 | 0.4 | 0.4 | 0 | 0 | 0 | 0.4 |
| MB50-320 | 3 | 3 | 3 | 3 | 3 | 3 |
| Irganox 1010 | 0.1 | 0.1 | 0.1 | 0.1 | 0.1 | 0.1 |

| Cracking under 150 C., | | | | | | |
|---|---|---|---|---|---|---|
| 1 hour, 3 m/m rod | Uncoated Mg(OH)₂ | | Coated Mg(OH)₂ | | CaC0₃ | ATH |
| Severe¹ | X | X | — | — | — | — |
| Moderate² | — | — | X | X | — | — |
| None | — | — | — | — | X | X |

¹Severe = One or more cracks of 1 mm or greater width.
²Moderate = No cracks of 1 mm or greater width.

Additional compositions are tested to identify the effect of the density of the single-site elastomer on the physical properties. In these evaluations, both ethylene-octene and ethylene-butene single-site copolymers are examined as shown in Table 2. To meet many standards, customers require the compound to have a minimum tensile strength of 10 MPa and minimum tensile elongation of 125%. Surprisingly, an optimal density of the co-resin, less than 0.90 g/cc, is found to result in an acceptable tensile elongation performance. In addition, processability of the final compound is shown to be improved with the elastomer having a melt index greater than or equal to 1 g/10 min.

TABLE 2
Effect of Co-Resin on Mechanical Properties of EEA-Based Systems

| Composition Component | Ex. 3 | Ex. 4 | Ex. 5 | Ex. 6 | Ex. 7 | Ex. 8 |
|---|---|---|---|---|---|---|
| Amplify EA 100 | 19.7 | 19.7 | 19.7 | 19.7 | 19.7 | 19.7 |
| Amplify GR 208 | 6 | 6.0 | 6 | 6 | 6 | 6 |
| Affinity KC-8852G | 10.9 | 0 | 0 | 0 | 0 | 0 |
| Affinity EG 8100G | 0 | 10.9 | 0 | 0 | 0 | 0 |
| Engage ENR 7380.00 | 0 | 0 | 10.9 | 0 | 0 | 0 |
| Engage ENR 7360.00 | 0 | 0 | 0 | 10.9 | 0 | 0 |
| Affinity PL 1880G | 0 | 0 | 0 | 0 | 10.9 | 0 |
| Affinity PL 1850G | 0 | 0 | 0 | 0 | 0 | 10.9 |
| Hubercarb G3T | 5 | 5 | 5 | 5 | 5 | 5 |
| Magshield UF | 55 | 55 | 55 | 55 | 55 | 55 |
| Industrene 5016 | 0.4 | 0.4 | 0.4 | 0.4 | 0.4 | 0.4 |
| MB50-320 | 3 | 3 | 3 | 3 | 3 | 3 |
| Irganox 1010 | 0.1 | 0.1 | 0.1 | 0.1 | 0.1 | 0.1 |
| Tensile Strength, MPa | 11 (1600) | 11.4 (1660) | 11.2 (1620) | 11 (1600) | 12.4 (1800) | 12.2 (1770) |
| (psi) | | | | | | |
| Tensile Elongation % | 150 | 180 | 150 | 140 | 100 | 100 |
| Tear Strength, N/mm | 6.3 (36) | 5.6 (32) | 7 (40) | 6.5 (37) | 6.5 (37) | 6.3 (36) |
| (ibf/in) | | | | | | |
| Processability | good | — | poor | — | — | — |
| (good/poor)* | | | | | | |

*Good = FI ≧ 3 g/10 min, Poor = FI < 3 g/10 min, where FI is Flow Index tested at 190 C. using a 21.6 kg mass.

The effect of the filler type on mechanical and flame properties was also examined, and is shown in Table 3. Surprisingly, the ATH filler in the EEA/metallocene elastomer system gave a significant improvement on physical properties compared to the Mg(OH)₂ filler (Ex. 11 vs Ex. 9). However, in an ATH-filled system smoke generation can be higher than in a magnesium hydroxide filled system. Therefore, the addition of smoke suppression synergists are desired to reduce the smoke generated during the ASTM E-662 test. Examples of effective smoke suppressants are shown in Table 3 (Ex. 12 and Ex. 13).

These smoke suppressants, surprisingly, do no significantly decrease the mechanical properties while decreasing the smoke generated during the test. As a comparative example, data for commercial material DFDA-1643 NT is shown. The smoke suppressants shown in Table 3 provided a compound with lower smoke than 1643 while maintaining sufficient mechanical properties. The highly filled ATH and smoke suppressant system is able to attain a high level of flame retardance, as demonstrated by the V-0 UL-94 performance.

In all cases, the following conditions are used. Compounding is conducted using a laboratory scale Brabender mixer with methods well known in the art. Tensile properties are tested according to ASTM D638 on 0.075″ plaque specimens. Tear strength properties are tested according to ASTM D470 on 0.075″ plaque specimens. Smoke Density is tested according to ASTM E-662 on 0.020″ plaque specimens. The UL-94 performance is tested according to UL-1581 on 0.125″ plaque samples.

TABLE 3
Effect of Filler on Flame and Mechanical Properties of EEA/Homogeneous Polyethylene Systems

| | Comp. Ex. 5 | | | | | |
|---|---|---|---|---|---|---|
| | [DFDA-1643 NT] | Ex. 9 | Ex. 10 | Ex. 11 | Ex. 12 | Ex. 13 |
| Amplify EA-100 | 31.7 | 31.7 | 31.7 | 31.7 | 29.7 | 31.7 |
| Amplify GR-208 | 6 | 6 | 6 | 6 | 6 | 6 |
| Affinity KC 8852G | 10.9 | 10.9 | 10.9 | 10.9 | 10.9 | 109 |
| Hubercarb G3T | 5 | 0 | 5 | 0 | 0 | 0 |
| PGA ATH | 55 | 0 | 0 | 60 | 60 | 50 |
| Magshield UF | 0 | 60 | 55 | 0 | 0 | 10 |
| Zinc Borate | 0 | 0 | 0 | 0 | 2 | 0 |
| Industrene 5016 | 0.4 | 0.4 | 0.4 | 0.4 | 0.4 | 0.4 |
| MB50-320 | 3 | 3 | 3 | 3 | 3 | 3 |
| Irganox 1010 | 0.1 | 0.1 | 0.1 | 0.1 | 0.1 | 0.1 |
| Tensile Strength, MPa | 12.4 (1800) | 10.7 (1550) | 11 (1600) | 11.7 (1700) | 12.4 (1800) | 12 (1740) |
| (psi) | | | | | | |
| Tensile Elongation % | 220 | 130 | 150 | 240 | 230 | 200 |
| Tear Strength, N/mm | 8.8 (50) | 5.8 (33) | 6.3 (36) | 8.8 (50) | 8.6 (49) | 7.8 (45) |
| (lbf/in) | | | | | | |
| UL-94 Rating | V-0 | — | V-1 | V-0 | V-0 | V-0 |
| Smoke Density, | — | — | — | — | — | — |
| ASTM E-662 | | | | | | |
| Non-Flaming, Dm | 133 | — | — | 131 | 107 | 100 |
| (Corrected) | | | | | | |
| Flaming, Dm | 63 | — | — | 25 | 22 | 22 |
| (Corrected) | | | | | | |

Although the invention has been described in considerable detail by the preceding examples, this detail is for the purpose of illustration and is not to be construed as a limitation upon the scope and spirit of the appended claims. All U.S. patents, allowed U.S. patent applications and U.S. patent application Publications cited above are incorporated herein by reference.

1. A composition comprising:
(A) 15 to 25 wt % of at least one of EEA and EBA;
(B) 5 to 15 wt % of a homogeneous polyethylene;
(C) 3 to 12 wt % of an ethylenic resin modified with a compound or compounds containing an organo-functional group;
(D) 40 to 65 wt % of a non-halogenated flame retardant; and
(E) 1 to 8 wt % of a silicone polymer.

2. (canceled)

3. The composition of claim 1 in which the homogeneous polyethylene comprises units derived from a C₃₋₁₂ α-olefin.

4-5. (canceled)

6. The composition of claim 1 in which the functional group of the ethylenic resin (C) is a unit derived from maleic anhydride.

7-8. (canceled)

9. The composition of claim 1 in which the non-halogenated flame retardant is at least one of ATH, red phosphorous, silica, alumina, titanium oxide, carbon nanotubes, talc, clay, organo-modified clay, calcium carbonate, zinc borate, antimony trioxide, wollastonite, mica, ammonium octamolybdate, frits, hollow glass microspheres, intumescent compounds and expanded graphite.

10. The composition of claim 1 in which the non-halogenated flame retardant is ATH.

11-15. (canceled)

16. The composition of claim 1 in which the silicone polymer is of the formula:
R—Si—O—(RSiO)ₙ—R—Si—O—R
in which each R is independently a saturated or unsaturated alkyl group, an aryl group, or a hydrogen atom, and n is a number of 1 to 5000.

17. The composition of claim 1 in which the silicone polymer is at least one of glycidyl-modified silicate, amino-modified silicate, mercapto-modified silicate, polyether-modified silicate, carboxylic acid modified silicate, or higher fatty acid modified silicate.

18. The composition of claim 1 in which the silicone polymer has a viscosity greater than 5,000,000 centistokes at 23 C.

19. The composition of claim 1 in which the silicone polymer is an ultra-high molecular weight polydimethylsiloxane.

20. The composition of claim 1 in which a smoke suppressant is present in an amount of 1 to 20 wt %.

21. The composition of claim 20 in which the smoke suppressant is at least one of magnesium hydroxide, zinc borate, a magnesium/zinc/antimony complex, a magnesium/zinc complex and an anhydrous sodium antimonate.

22. (canceled)

23. The composition of claim 1 in which the EEA and/or EBA comprises between 18 and 21 wt % based on the weight of the composition.

24. The composition of claim 23 in which the homogeneous polyethylene comprises between 8 and 12 wt % based on the weight of the composition.

25. The composition of claim 24 in which the modified ethylenic resin (C) comprises between 5 and 8 wt % based on the weight of the composition.

26. The composition of claim 25 in which the non-halogenated flame retardant comprises between 50 and 55 wt % based on the weight of the composition.

27. The composition of claim 26 in which the silicone polymer comprises between 3 and 6 wt % based on the weight of the composition.

28. (canceled)

29. A cable insulation layer comprising the composition of claim 1.

30. A cable protective outer jacket comprising the composition of claim 1.

31. A cable core sheath comprising the composition of claim 1.

32. A cable comprising one or more electrical conductors or communications media, or a core of two or more electrical conductors or communications media, at least one of the electrical conductor, communications medium, or core being surrounded by a sheath comprising the composition of claim 1.
